(19) United States
(12) Patent Application Publication
(10) Pub. No.: US 2018/0018731 A1
(43) Pub. Date: Jan. 18, 2018

(54) VEHICLE SERVICING SYSTEM

(71) Applicant: Jason Rodriguez, Wolcott, CT (US)

(72) Inventor: Jason Rodriguez, Wolcott, CT (US)

(21) Appl. No.: 15/641,586

(22) Filed: Jul. 5, 2017

Related U.S. Application Data
(60) Provisional application No. 62/362,753, filed on Jul. 15, 2016.

(51) Int. Cl. G06Q 30/06; G06Q 20/10; H04W 4/20; G06Q 50/30

(52) U.S. Cl. CPC G06Q 30/0645; H04W 4/20; G06Q 20/102; G06Q 50/30

(57) ABSTRACT

A vehicle servicing system comprising: a smartphone; a vehicle servicing app installed on the smartphone, where the app is configured to perform a method, the method comprising: engaging app; inputting vehicle information into app if not already saved, or changed from last time inputted; displaying local participating service shops and pricing for services; determining how long user will be at current location or at other location in the future; determining whether there will be a need for a loaner vehicle; confirming services from a local service shop, if no need for a loaner vehicle; making payment; determining whether user accepts additional services suggested by service shop; payment for additional services, if user accepts additional services. A non-transitory computer-readable medium includes a set of instructions stored thereon that when accessed by a processor enable the processor to run an app to perform a method for vehicle servicing, the method comprising: engaging app; inputting vehicle information into app if not already saved, or changed from last time inputted; displaying local participating service shops and pricing for services; determining how long user will be at current location or at other location in the future; determining whether there will be a need for a loaner vehicle; confirming services from a local service shop, if no need for a loaner vehicle; making payment; determining whether user accepts additional services suggested by service shop; payment for additional services, if user accepts additional services.

### CROSS-REFERENCES

This patent application claims the benefit of U.S. Provisional Patent Application No. 62/362,753 by inventor Jason Rodriquez entitled “AUTOMOBILE SERVICE APPLICATION,” filed on Jul. 15, 2016, and which provisional application is fully incorporated by reference herein.

### TECHNICAL FIELD

The present invention relates in general to method of scheduling service on a vehicle, and in particular to a mobile software application that allows users to schedule service on their vehicles.

### BACKGROUND

There is no easy, convenient way for people to have their vehicle serviced without physically going to a car service facility. All vehicles need to be serviced. People often do not like to walk into a service area, wait, or get rides. Additionally, taking time off from work can be a financial drain as well as an inconvenience. There has also been a significant increase in the amount of recalls on new vehicles creating a further need to go out of your way to find time to maintain and repair your vehicle. Currently, people make appointments, then set up rides, get a loaner at the dealership, or stay with their vehicle at the dealership, and wait until the service is done. All this has to be done at the service establishment. This is a very inefficient system.

Thus there is a need for a vehicle servicing system that overcomes the above listed and other disadvantages.

### SUMMARY OF THE INVENTION

The invention relates to a vehicle servicing system comprising: a smartphone; a vehicle servicing app installed on the smartphone, where the app is configured to perform a method, the method comprising: engaging app; inputting vehicle information into app if not already saved, or changed from last time inputted; displaying local participating service shops and pricing for services; determining how long user will be at current location or at other location in the future; determining whether there will be a need for a loaner vehicle; confirming services from a local service shop, if no need for a loaner vehicle; making payment; determining whether user accepts additional services suggested by service shop; payment for additional services, if user accepts additional services.

The invention also relates to a non-transitory computer-readable medium includes a set of instructions stored thereon that when accessed by a processor enable the processor to run an app to perform a method for vehicle servicing, the method comprising: engaging app; inputting vehicle information into app if not already saved, or changed from last time inputted; displaying local participating service shops and pricing for services; determining how long user will be at current location or at other location in the future; determining whether there will be a need for a loaner vehicle; confirming services from a local service shop, if no need for a loaner vehicle; making payment; determining whether user accepts additional services suggested by service shop; payment for additional services, if user accepts additional services.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a flowchart showing one embodiment of a portion of the disclosed app;

FIG. 2 is a flowchart showing the remaining portion of the disclosed app from FIG. 1; and

FIG. 3 is a flowchart showing another embodiment of the disclosed app.

### DETAILED DESCRIPTION OF THE INVENTION

The invention is a mobile software application that makes servicing the vehicle as easy as clicking on a button on your phone or device. A mobile software application or “app” is a software application designed to run on a mobile device such as a smartphone, tablet, computer, smart watch, etc. It will allow you to request services to be done while you are at home or at work. Your vehicle may be picked up from the desired location, such as work, school, home, etc., with instructions of what needs to be done, when it needs to be done, and by what time the vehicle needs to be returned. It solves both the issue of customers not wanting to be hassled by going to the service department, and the service department's desire to create a larger customer base.

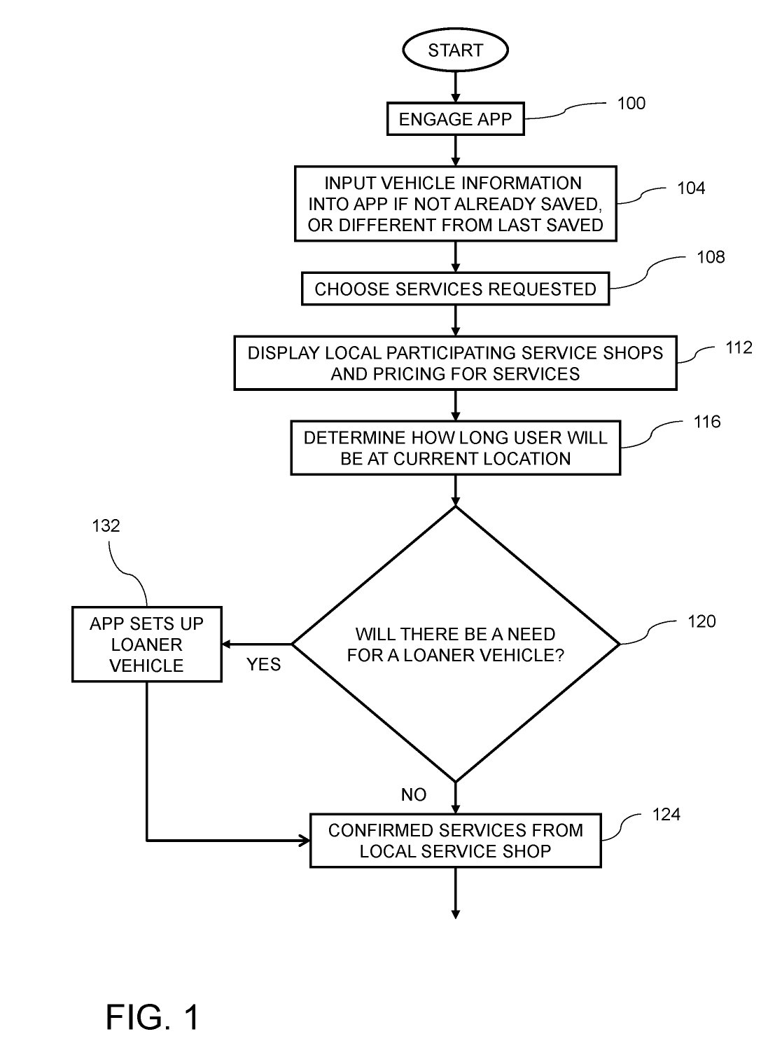

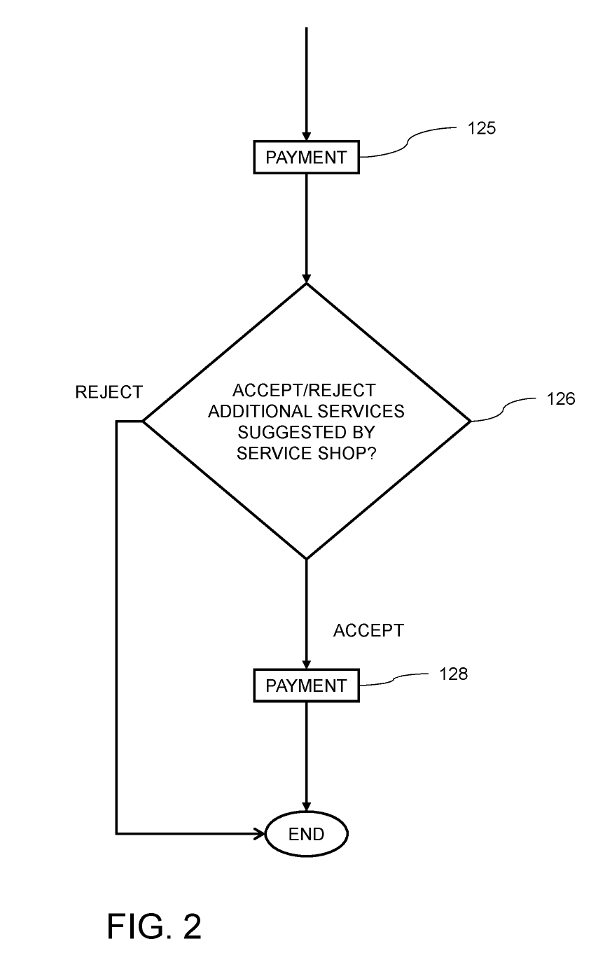

FIGS. 1 and 2 are flowcharts showing the steps the app may perform for the consumer/user. At act 100 the user engages the app. At act 104 the user inputs her vehicle information into app if not already saved, or if the information has changed from the last time the user used the app. At act 108 the user chooses the services she desires for her vehicle. Services may include, and are not limited to oil change, scheduled maintenance, air conditioning recharge, check a particular issue known to user, tune-up, rotate tires, state required inspection, etc. At act 112, the app displays the local participating service shops, dealers and/or other vehicle service providers and pricing for services at those service shops, dealers, and other vehicle service providers. In this document, service shops will include dealers, service shops, and other vehicle service providers. At act 116, the user inputs how long she will be at her current location. In addition, if the user will be at a particular location at some point in the future for a specific amount of time, the user can input that information at act 116. At query 120, the user indicates whether she needs a loaner vehicle. At act 124, the app will confirm that user has selected and that the dealer will provide the requested services. At act 125, the user will make payment. At act 126 the user can accept or reject additional services suggested by the dealer. At act 128, the user will make payment with respect to the additional services if necessary. At act 132, the user will set up a loaner vehicle with the dealer.

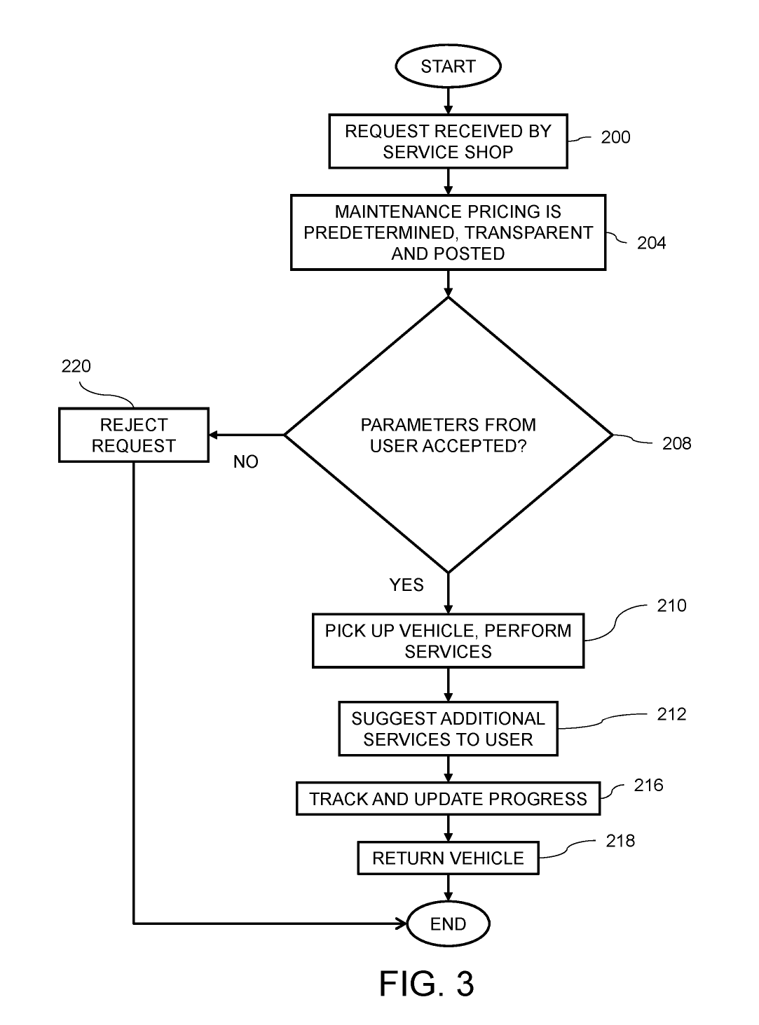

FIG. 3 is a flowchart showing the steps the app may perform for the dealer or other service provider. At act 200 a service request is sent to the service department. At act 204, all maintenance pricing is predetermined, transparent, and posted with respect to the service department. At query 208, the service determines whether to accept the parameters from the user. At act 210, the service department will pick up vehicle, and perform service on the vehicle. At act 212, the service department can suggest additional services to the user. At act 216, the dealer or other service provider will provide information to the app so that the app will track and update progress for the user. At act 218, the service department will return the vehicle to the user. At act 220, the dealer may reject the service request.

The app will help car dealers to capture additional service business, and in signing up with the app, they can be more reachable, and transparent to their current customer base, as well as allow it to grow with our changing times. In addition, there will be a consumer based rating system for services rendered.

Throughout this patent application, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium. For example, a server can include one or more computers operating as a web server, database server, or other type of computer server in a manner to fulfill described roles, responsibilities, or functions. Within the context of this document, the disclosed smart phones, tablets, or hand held computers are also deemed to comprise computing devices having a processor and a non-transitory memory storing instructions executable by the processor that cause the device to control, manage, or otherwise manipulate the features of the disclosed apparatuses, systems and methods.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A vehicle servicing system comprising:
a smartphone;
a vehicle servicing app installed on the smartphone, wherein the app is configured to perform a method, the method comprising:
engaging app;
inputting vehicle information into app if not already saved, or changed from last time inputted;
displaying local participating service shops and pricing for services;
determining how long user will be at current location or at other location in the future;
determining whether there will be a need for a loaner vehicle;
confirming services from a local service shop, if no need for a loaner vehicle;
making payment;
determining whether user accepts additional services suggested by service shop;
payment for additional services, if user accepts additional services.

2. The vehicle servicing system of claim 1, wherein the method further comprises:
setting up loaner vehicle for user, if it is determined there is a need for a loaner vehicle.

3. The vehicle servicing system of claim 2, wherein the method further comprises:
receiving service request by service shop;
determining whether service request by user is accepted;
sending someone from service shop to pick up vehicle from user, and perform requested services at service shop;
suggesting additional services to user;
displaying and updating progress on vehicle to the user;
returning vehicle to user.

4. The vehicle servicing system of claim 3, wherein the method further comprises:
rejecting request, if service request by user is rejected.

5. A non-transitory computer-readable medium includes a set of instructions stored thereon that when accessed by a processor enable the processor to run an app to perform a method for vehicle servicing, the method comprising:
engaging app;
inputting vehicle information into app if not already saved, or changed from last time inputted;
displaying local participating service shops and pricing for services;
determining how long user will be at current location or at other location in the future;
determining whether there will be a need for a loaner vehicle;
confirming services from a local service shop, if no need for a loaner vehicle;
making payment;
determining whether user accepts additional services suggested by service shop;
payment for additional services, if user accepts additional services.

6. The non-transitory computer-readable medium of claim 5, wherein the method further comprises:
setting up loaner vehicle for user, if it is determined there is a need for a loaner vehicle.

7. The non-transitory computer-readable medium of claim 6, wherein the method further comprises:
receiving service request by service shop;
determining whether service request by user is accepted;
sending someone from service shop to pick up vehicle from user, and perform requested services at service shop;
suggesting additional services to user;
displaying and updating progress on vehicle to the user;
returning vehicle to user.

8. The non-transitory computer-readable medium of claim 7, wherein the method further comprises:
rejecting request, if service request by user is rejected.
